(19) United States
(12) Patent Application Publication
(10) Pub. No.: US 2009/0172182 A1
(43) Pub. Date: Jul. 2, 2009

(54) SYSTEM AND METHOD FOR MULTIMEDIA STREAMING SERVICE

(75) Inventor: Dae Eui Yoon, Suwon-si (KR)

Correspondence Address: Jefferson IP Law, LLP, 1730 M Street, NW, Suite 807, Washington, DC, 20036, US

(73) Assignee: Samsung Electronics Co. Ltd., Suwon-si (KR)

(21) Appl. No.: 12/343,037

(22) Filed: Dec. 23, 2008

(30) Foreign Application Priority Data
Dec. 28, 2007 (KR) 10-2007-0139955

(51) Int. Cl. G06F 15/16

(52) U.S. Cl. 709/231

(57) ABSTRACT

A system and a method for a multimedia streaming service in a mobile communication device are provided for reducing power consumption. The mobile communication device determines a buffering size of a buffer according to characteristic information of the streams. The device receives the streams from the server, stores the streams in the buffer and plays the buffered streams. The mobile communication device requests a stream pause and the server stops a stream transmission. The server then sends a keep-alive request message to the device. The communication device then sends a keep-alive response message to the server when a keep-alive critical period expires.

### PRIORITY

This application claims the benefit under 35 U.S.C. §119(a) of a Korean patent application filed on Dec. 28, 2007 in the Korean Intellectual Property Office and assigned Serial No. 10-2007-0139955, the entire disclosure of which is hereby incorporated by reference.

### BACKGROUND OF THE INVENTION

1. Field of the Invention

The present invention relates to multimedia streaming technology. More particularly, the present invention relates to a system and method for a multimedia streaming service for reducing power consumption.

2. Description of the Related Art

Most Internet access is not fast enough to download large multimedia files quickly. Streaming is a technique for delivering web-based multimedia files such as video, audio, animation, and the like so that the multimedia files may be processed as a steady and continuous stream at a requesting client. A streaming service provides a multimedia content to Internet users, without having to wait for content to completely download to hard disk drives. Through caching, content is played as it is received and buffering mechanisms ensure that the content is played smoothly.

Theoretically, a streaming content plays to an end user or viewer as an immediate and ongoing broadcast. Practically, a small-sized content, such as audio, implements real-time delivery and play since the small-sized content does not require a large bandwidth and sufficient memory. However, large-sized content, such as video is often affected by the state of a delivery network or performance of an end user's device. For instance, receiving video and playing video with high definition requires a faster data-transmission network and a higher performance device.

On the other hand, streaming for mobile communication devices generally employs a wireless communication network with a relatively smaller bandwidth. Additionally, most mobile communication devices have insufficient memory capacity and relatively lower performance. Unfortunately, these drawbacks may restrict effective and reliable streaming of multimedia contents to mobile communication devices. In particular, playing multimedia streams in mobile communication devices requires relatively higher power consumption due to continuous receiving and buffering of streams.

Therefore, a need exists for an improved system and method for playing multimedia streams in a mobile communication device with a reduction in power consumption.

### SUMMARY OF THE INVENTION

An aspect of the present invention is to address at least the above-mentioned problems and/or disadvantages and to provide at least the advantages described below. Accordingly, an aspect of the present invention is to provide a system and method for a multimedia streaming service in a mobile communication device, allowing a reduction in power consumption.

In accordance with an aspect of the present invention, a method for a multimedia streaming service in a mobile communication device having a buffer for storing multimedia streams transmitted from a multimedia server is provided. This method includes determining a buffering size of the buffer according to characteristic information of the multimedia streams; storing the multimedia streams in the buffer, the multimedia streams being transmitted from the multimedia server; and playing the multimedia streams stored in the buffer.

In accordance with another aspect of the present invention, a method for a multimedia streaming service in a multimedia streaming service system having a multimedia server and a mobile communication device with a buffer for storing multimedia streams is provided. The method includes at the mobile communication device, storing the multimedia streams in the buffer, the multimedia streams being transmitted from the multimedia server to the mobile communication device; at the mobile communication device, playing the multimedia streams stored in the buffer; at the multimedia server, stopping a transmission of the multimedia streams when receiving a stream pause request from the mobile communication device, and sending a keep-alive request message to the mobile communication device; and at the mobile communication device, determining whether a keep-alive critical period expires when receiving the keep-alive request message from the multimedia server, and, if the keep-alive critical period expires, sending a keep-alive response message to the multimedia server.

In accordance with yet another aspect of the present invention, a system for a multimedia streaming service is provided. This system includes a multimedia server storing multimedia streams and characteristic information thereof, and transmitting the multimedia streams in response to a stream request; and a mobile communication device having a buffer, determining a buffering size of the buffer according to the characteristic information of the multimedia streams, storing the multimedia streams being transmitted from the multimedia server in the buffer, and playing the multimedia streams stored in the buffer.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a schematic view illustrating a system for a multimedia streaming service in accordance with an exemplary embodiment of the present invention.

FIG. 2 is a flow diagram illustrating a method for a multimedia streaming service in accordance with an exemplary embodiment of the present invention.

FIG. 3 is a block diagram illustrating a mobile communication device of a multimedia streaming service system in accordance with an exemplary embodiment of the present invention.

FIG. 4 is a flow diagram illustrating a method for providing a multimedia streaming service in a mobile communication device in accordance with an exemplary embodiment of the present invention.

FIG. 5 is a flow diagram illustrating a detailed process for determining a buffering size in accordance with an exemplary embodiment of the present invention.

FIG. 6 is a flow diagram illustrating a detailed process for performing a streaming service in accordance with an exemplary embodiment of the present invention.

FIG. 7 is a flow diagram illustrating a detailed process for suspending a receiving of streams in accordance with an exemplary embodiment of the present invention.

FIG. 8 is a flow diagram illustrating a detailed process for suspending a playing of streams in accordance with an exemplary embodiment of the present invention.

Throughout the drawings, it should be noted that like reference numbers are used to depict the same or similar elements, features and structures.

### DETAILED DESCRIPTION OF EXEMPLARY EMBODIMENTS

The following description with reference to the accompanying drawings is to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constrictions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Hereinafter, well-known configurations and processes may not be described or illustrated in detail to avoid obscuring the essence of exemplary embodiments of the present invention. Among terminologies used herein, “multimedia stream characteristic information” denotes inherent or predefined features of multimedia streams stored in a multimedia server and provided to a mobile communication device. This multimedia stream characteristic information may include “a multimedia stream expiration date” and/or “an association time-out period”. A multimedia stream expiration date denotes a specific time by which a multimedia stream can exist in a multimedia server. This multimedia stream expiration date may be determined by a multimedia server. An association time-out period denotes a time span within which an interconnection is maintained, without communication, between a multimedia server and a mobile communication device. These association timeout periods may vary according to multimedia servers. Also, the association timeout period may be determined by a multimedia server.

Additionally, “a pause allowed period” denotes a time span within which a multimedia server is allowed to pause without communication. For example, a pause allowed period is defined as the specific extent of time from a pause in a stream transmission or from the receipt of a keep-alive response message in a multimedia server. If a pause allowed period expires, a multimedia server may send a keep-alive request message to a mobile communication device. “A keep-alive request message” denotes a message of a multimedia server querying whether a mobile communication device keeps a communication state. “A keep-alive response message” denotes a message of a mobile communication device reporting maintenance of a communication state in response to a keep-alive request message. “A keep-alive time-out period” denotes the maximum time span allowing a multimedia server to be on standby from a transmitting point of a keep-alive request message to a receiving point of a keep-alive response message. “A keep-alive critical period” denotes a minimum time span allowing a mobile communication device to be on standby from a receiving point of a keep-alive request message to a transmitting point of a keep-alive response message. A keep-alive critical period should be shorter than a keep-alive time-out period. That is, if receiving a keep-alive request message, a mobile communication device should send a keep-alive response message after its own keep-alive critical period expires and before a keep-alive time-out period of a multimedia server expires. A keep-alive time-out period and a keep-alive critical period may vary according to communication conditions between a mobile communication device and a multimedia server.

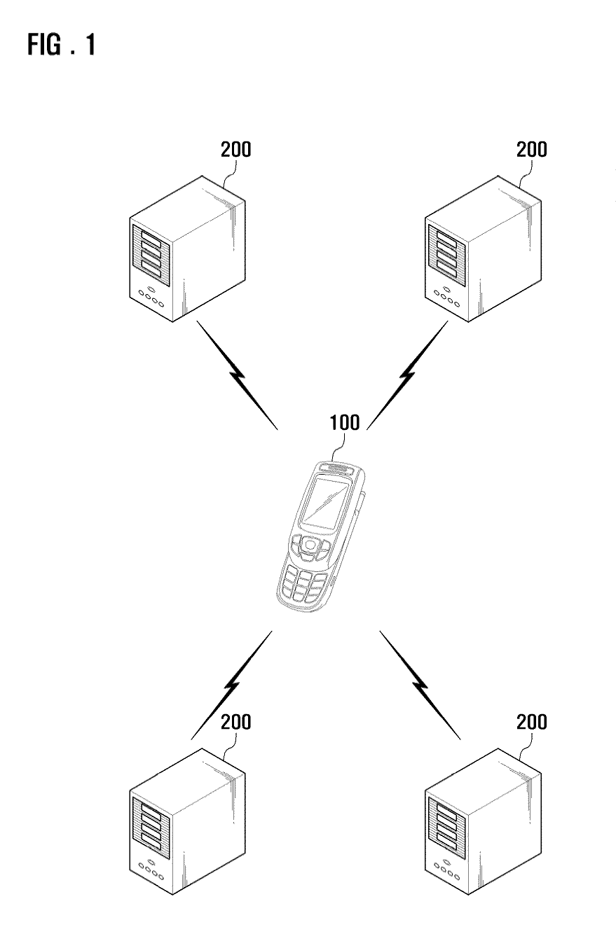

FIG. 1 is a schematic view illustrating a system for a multimedia streaming service in accordance with an exemplary embodiment of the present invention.

Referring to FIG. 1, the multimedia streaming service system includes at least one mobile communication device 100 and at least one multimedia server 200, which are interconnected through a wireless communication network. The mobile communication device 100 may be one of a mobile phone, a Personal Digital Assistant (PDA), and the like. Using protocols such as Wireless Application Protocol (WAP) and Hypertext Transfer Protocol (HTTP), the mobile communication device 100 offers a variety of multimedia-related functions to end users. The multimedia server 200 stores a large number of multimedia streams and multimedia streams characteristic information. At a user's request, the multimedia server 200 transmits the multimedia streams to the mobile communication device 100. The mobile communication device 100 then temporarily stores received multimedia streams in its buffer.

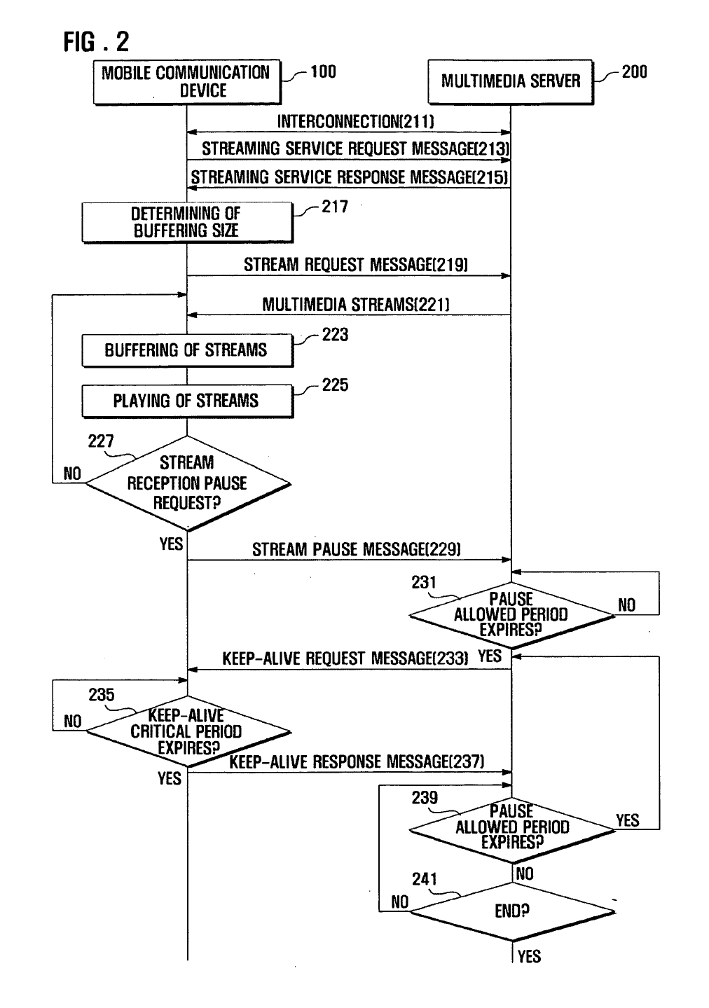

FIG. 2 is a flow diagram illustrating a method for a multimedia streaming service in accordance with an exemplary embodiment of the present invention.

Referring to FIG. 2, in step 211, the mobile communication device 100 and the multimedia server 200 are interconnected to each other. Then, in step 213, the mobile communication device 100 sends a streaming service request message to the multimedia server 200. On receipt of this request message, the multimedia server 200 sends a streaming service response message to the mobile communication device 100 in step 215. This response message may include the multimedia stream characteristic information. On receipt of the response message, in step 217, the mobile communication device 100 determines a buffering size suitable for the requested streaming service by using the received characteristic information. Buffering sizes may vary depending on the multimedia servers 200 in the system.

In step 219, the mobile communication device 100 sends a stream request message to the multimedia server 200. When receiving this stream request message, the multimedia server 200 transmits the requested multimedia streams to the mobile communication device 100 in step 221. In step 223, the mobile communication device 100 temporarily stores, i.e., buffers, the transmitted streams in a buffer. While buffering the following streams, the mobile communication device 100 plays already buffered streams in step 225. Here, the rate of playing the buffered streams may be different in general from the rate of buffering the received streams.

While buffering and playing continuous streams, the mobile communication device 100 determines, in step 227, whether a request for pausing in the reception of streams is input. If there is a stream reception pause request, the mobile communication device 100 sends a stream pause message to the multimedia server 200 in step 229. This stream pause message is to request the multimedia server 200 to stop transmitting streams. If there is no input of a stream reception pause request in step 227, the mobile communication device 100 returns to step 221 and continues to receive, buffer and play the multimedia streams.

When receiving a stream pause message in step 229, the multimedia server 200 stops the transmission of streams and then, in step 231, determines whether the pause allowed period expires. If a pause allowed period expires, the multimedia server 200 sends a keep-alive request message to the mobile communication device 100 in step 233. The mobile communication device 100 receives the keep-alive request message and then, in step 235, determines whether a keep-alive critical period expires. If the keep-alive critical period expires, the mobile communication device 100 sends a keep-alive response message to the multimedia server 200 in step 237. Here, the mobile communication device 100 may send the keep-alive response message before the keep-alive time-out period expires in the multimedia server 200.

The multimedia server 200 receives the keep-alive response message and then, in step 239, determines again whether the pause allowed period expires. If the pause allowed period expires, the multimedia server 200 returns to step 233. However, if the pause allowed period does not expire, the multimedia server 200 determines, in step 241, whether a request for ending the current multimedia streaming service is input. If there is an end requesting input, the multimedia server 200 performs a necessary process for ending the multimedia streaming service.

Hereinafter, the above-discussed mobile communication device 100 will be described in detail.

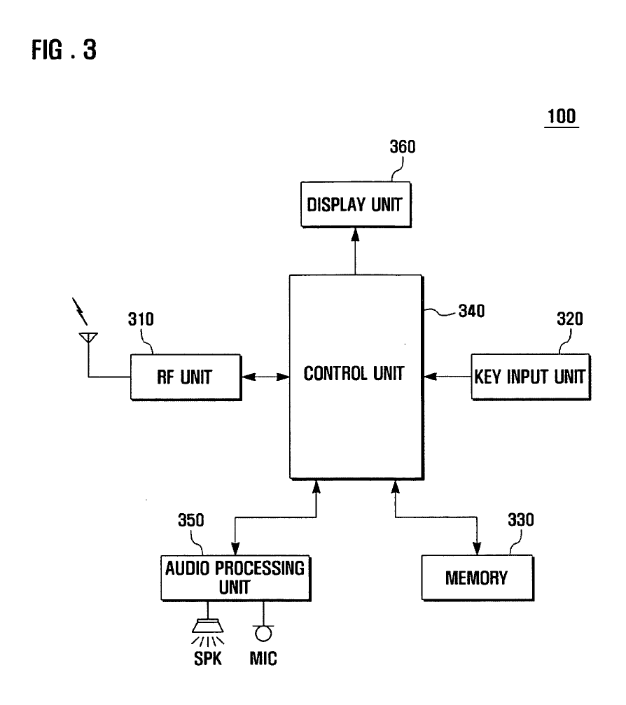

FIG. 3 is a block diagram illustrating a mobile communication device of a multimedia streaming service system in accordance with an exemplary embodiment of the present invention. An exemplary mobile phone may be employed as the mobile communication device.

Referring to FIG. 3, the mobile communication device 100 includes a Radio Frequency (RF) unit 310, a key input unit 320, a memory 330, a control unit 340, an audio processing unit 350 and a display unit 360.

The RF unit 310 includes an RF transmitter that up-converts a frequency of transmitted signals and amplifies the transmitted signals and an RF receiver that low-noise amplifies received signals and down-converts the frequency of the received signals. The RF unit 310 communicates with the multimedia server 200 when the mobile communication device 100 is interconnected to the multimedia server 200.

The key input unit 320 includes a number of alphanumeric keys and function keys arranged for efficient data entry. The function keys may have one or more of navigation keys, side keys, shortcut keys and the like.

The memory 330 may be composed of a program memory and a data memory. The program memory stores several programs necessary for controlling an operation of the mobile communication device 100. The data memory stores data created while the stored programs are performed. In particular, the memory 330 may include at least one buffer for temporarily storing streams received from the multimedia server 200. The buffer in the memory 330 may have different buffering sizes.

The control unit 340 controls the operation of the mobile communication device 100 and includes a data processor (not shown), which has a transmitter (not shown) for encoding and modulating transmitted signals and a receiver (not shown) for demodulating and decoding received signals. The data processor may be composed of a modem and a codec. Here, the codec has a data codec for processing packet data, an audio codec for processing audio signals and a video codec for processing video signals.

The control unit 340 determines a buffering size to be assigned to the multimedia server 200 when making access to the multimedia server 200. Here, the control unit 340 may assign different buffering sizes depending on the multimedia servers 200. Furthermore, the control unit 340 controls temporary storing of the received streams in the buffer and simultaneously controls playing of the buffered streams. Additionally, the control unit 340 controls transmission of a stream pause message to the multimedia server 200 when a request for pausing in the reception of streams is input. Also, when receiving a keep-alive request message from the multimedia server 200, the control unit 340 controls the transmission of a keep-alive response message to the multimedia server 200 after a keep-alive critical period expires and before a keep-alive time-out period expires.

The audio processing unit 350 reproduces audio signals, output from the audio codec of the data processor, through a speaker (SPK), or transmits audio signals, input from a microphone (MIC), to the audio codec of the data processor.

The display unit 360 displays various kinds of graphical information input by a user or to be offered to a user. The display unit 360 may employ a Liquid Crystal Display (LCD) device and the like. The display unit 360 may include a touch-screen, which also performs portions or all of the input unit functions.

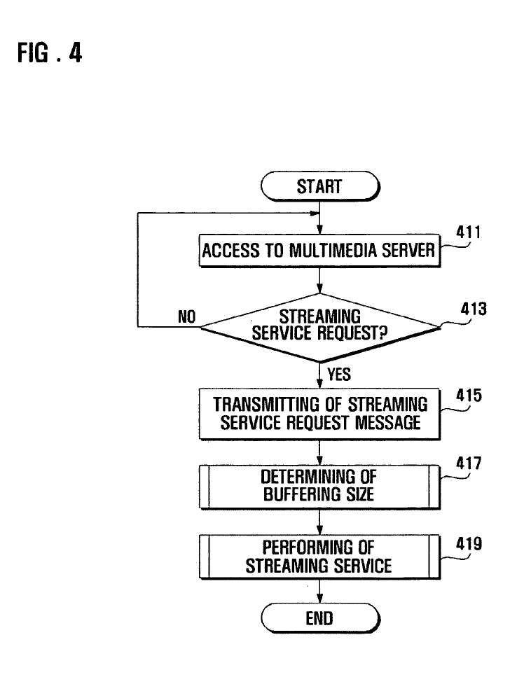

FIG. 4 is a flow diagram illustrating a method for providing a multimedia streaming service in a mobile communication device in accordance with an exemplary embodiment of the present invention.

Referring to FIGS. 3 and 4, in step 411, the control unit 340 accesses the multimedia server 200. If a request for a streaming service is input, the control unit 340 receives the request input in step 413 and then transmits a streaming service request message to the multimedia server 200 in step 415. The streaming service request message includes a selection of multimedia streams stored in the multimedia server 200.

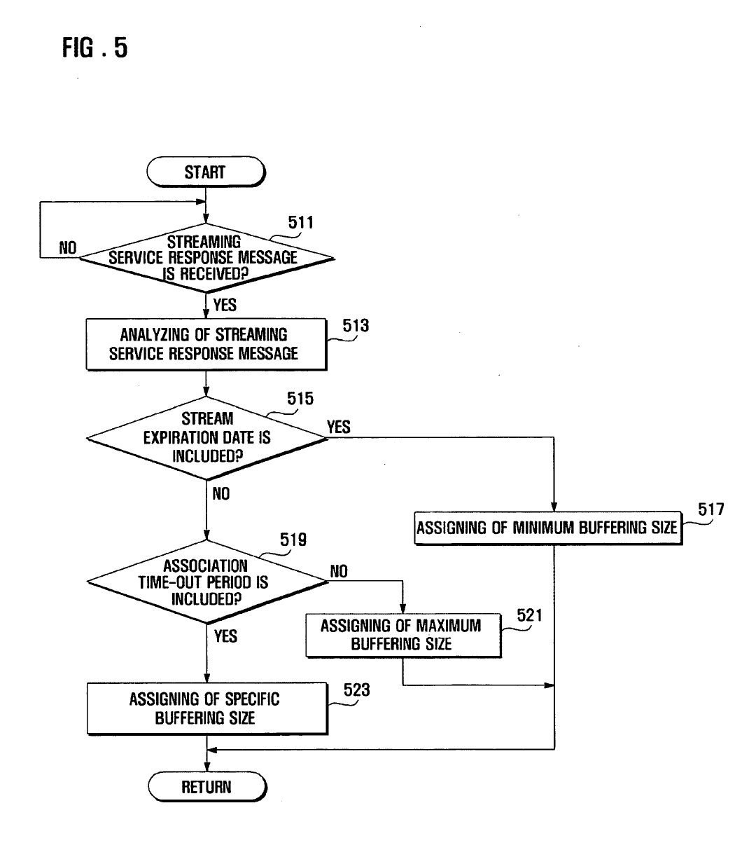

In step 417, the control unit 340 determines a buffering size. The buffering size may be determined in consideration of the multimedia server's 200 characteristics. A detailed process for determining the buffering size will be described later with reference to FIG. 5.

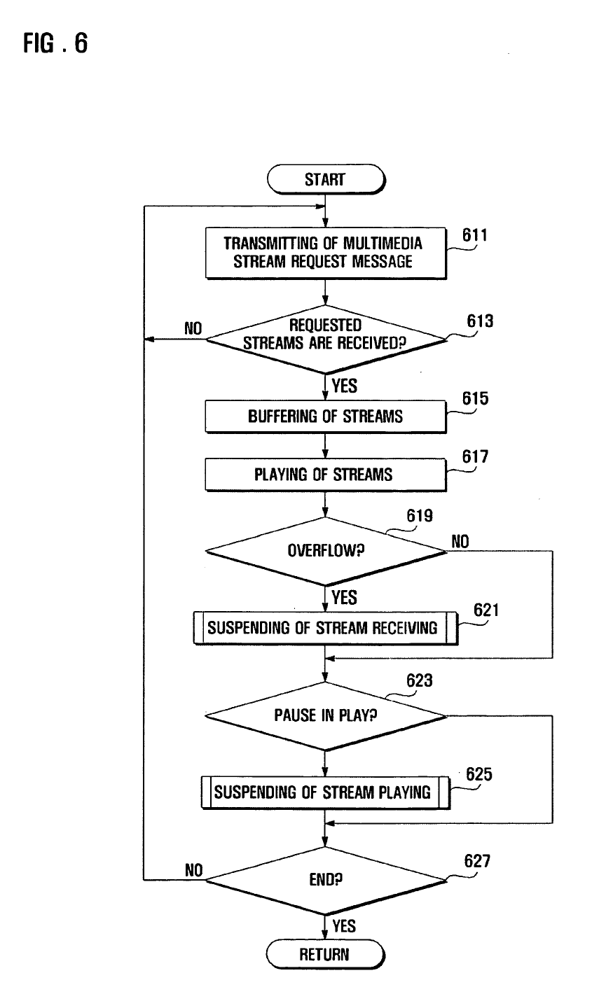

In step 419, the control unit 340 performs a streaming service. The performance of the streaming service may use the buffer with a specific buffering size assigned to the corresponding multimedia server 200. A detailed process of performing a streaming service will be described later with reference to FIG. 6.

FIG. 5 is a flow diagram illustrating a detailed process for determining a buffering size in step 417 in FIG. 4.

Referring to FIG. 5, if a streaming service response message in step 511 is received in response to a streaming service request message transmitted to the multimedia server 200 in step 415, the control unit 340 analyzes the received streaming service response message in step 513. The streaming service response message includes the multimedia stream characteristic information, such as an address of multimedia streams. More particularly, a streaming service response message may have an expiration date of multimedia streams and/or an Association Time-out Period (ATP) of the multimedia server 200.

Additionally, in step 515, the control unit 340 determines whether a streaming service response message includes a multimedia stream expiration date. If an expiration date is included, the control unit 340 assigns a minimum buffering size to the multimedia server 200 in step 517 and then proceeds to step 419 in FIG. 4.

However, if the expiration date is not included, the control unit 340 further determines whether the streaming service response message includes an association time-out period in step 519. If an association time-out period is not included, the control unit 340 assigns a maximum buffering size to the multimedia server 200 in step 521 and then proceeds to step 419 in FIG. 4.

On the other hand, if an association time-out period is included, the control unit 340 assigns a specific buffering size corresponding to an association timeout period in step 523 and then proceeds to step 419 in FIG. 4. As shown in Table 1 below, the memory 330 may store a table of buffering sizes to be assigned, depending on the association timeout period. For example, the minimum buffering size may be about seven seconds and the maximum buffering size may be about twenty-one seconds. Also, depending on each buffering size in Table 1, an upper critical value and a lower critical value may be determined based on an overflow of streams or an underflow of streams. For example, when a buffering size is about ten seconds, the upper critical value and the lower critical value may be about eight seconds and about two seconds, respectively.

TABLE 1

| | ATP (second) | | | | | |
|---|---|---|---|---|---|---|
| | Below | | | | | |
| | 30 | 30 | 60 | 90 | 120 | 150 |
| Buffering size | 7 | 10 | 11.5 | 12 | 13.5 | 14 |
| (second) | | | | | | |

| | ATP (second) | | | | | |
|---|---|---|---|---|---|---|
| | | | | | | Over 300 or Not |
| | 180 | 210 | 240 | 270 | 300 | defined |
| Buffering size | 15.5 | 16 | 17.5 | 18 | 21 | 21 |
| (second) | | | | | | |

FIG. 6 is a flow diagram illustrating a detailed process for performing a streaming service in step 419 in FIG. 4.

Referring to FIG. 6, after determining a buffering size in step 417 in FIG. 4, the control unit 340 transmits a multimedia stream request message to the multimedia server 200 in step 611. Then, if the requested streams are received in step 613, the control unit 340 stores the received streams in the buffer in step 615. While buffering the following streams, the control unit 340 plays streams already stored in the buffer in step 617. Here, the rate of playing streams may be different from the rate of buffering streams under the control of the control unit 340.

While buffering and playing continuous streams, the control unit 340 determines whether an overflow of streams occurs in step 619. Here, the overflow of streams denotes that the amount of buffered streams exceeds an upper critical value. If an overflow of streams occurs, the control unit 340 temporarily suspends the reception of streams in step 621. That is, the control unit 340 does not store the next streams and plays only the already buffered streams.

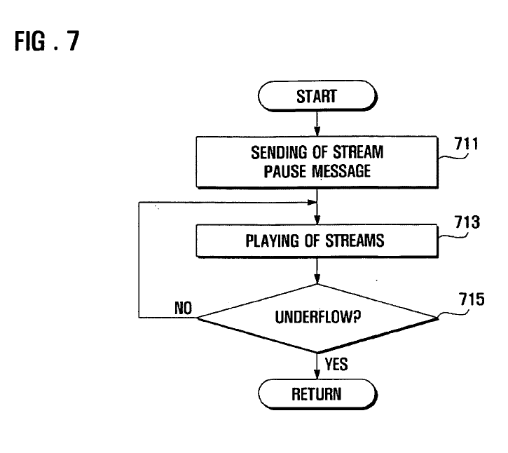

A detailed process of suspending the reception of streams is described hereinafter with reference to FIG. 7. FIG. 7 is a flow diagram illustrating a detailed process of suspending the receiving of streams in step 621 in FIG. 6.

Referring to FIG. 7, if an overflow of streams occurs, the control unit 340 sends a stream pause message to the multimedia server in step 711. Then the control unit 340 plays the already buffered streams in step 713. Thereafter, the control unit 340 determines whether an underflow of streams occurs in step 715. Here, underflow denotes an amount of buffered streams that falls below a lower critical value. If the underflow of streams occurs, the control unit 340 proceeds to step 625 in FIG. 6.

Returning to FIG. 6, in step 623, the control unit 340 determines whether a request for pausing a play of streams is input. If there is a pause request input, the control unit 340 temporarily suspends playing of streams in step 625. The pause request input may include various communication events such as a received call input through the RF unit 310 and a selection signal input through the key input unit 320 or touch screen. At this time, the control unit 340 neither stores new streams nor plays the already buffered streams.

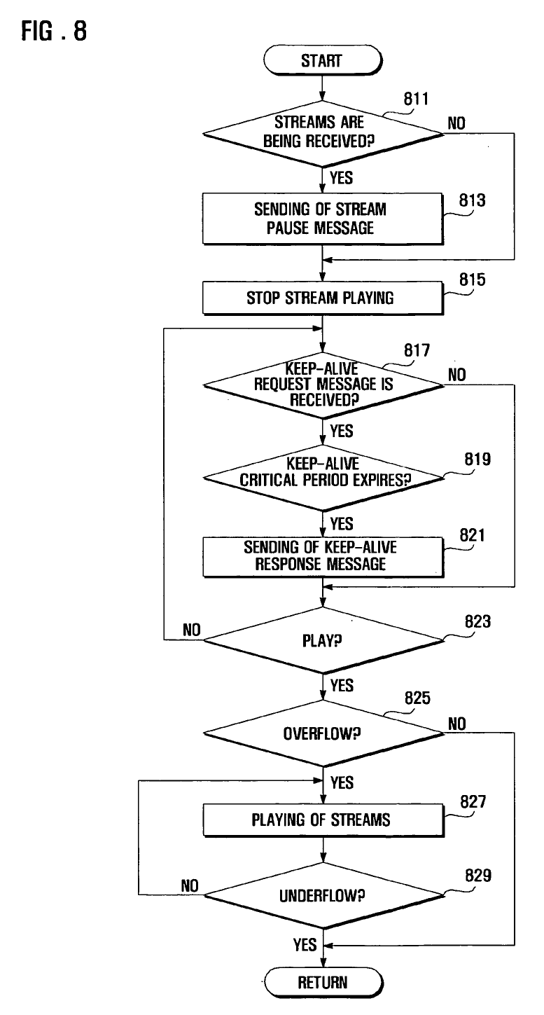

A detailed process of suspending a playing of streams is described hereinafter with reference to FIG. 8. FIG. 8 is a flow diagram illustrating a detailed process of suspending the playing of streams in step 625 in FIG. 6.

Referring to FIG. 8, in step 811, the control unit 340 determines whether streams are being received. If the streams are received, the control unit 340 sends a stream pause message to the multimedia server in step 813. Then the control unit 340 stops the playing of streams in step 815. Also, if streams are not received in step 811, the control unit 340 stops the playing of streams.

Next, in step 817, the control unit 340 determines whether a keep-alive request message is received from the mobile communication device. If a keep-alive request message is received, the control unit 340 further determines whether a keep-alive critical period expires in step 819. If a keep-alive critical period expires, the control unit 340 sends a keep-alive response message to the multimedia server in step 821.

Thereafter, in step 823, the control unit 340 determines whether a request for playing streams is input. If a play request is input, the control unit 340 further determines whether an overflow of streams occurs in step 825. If an overflow of streams does not occur, the control unit 340 proceeds to step 627 in FIG. 6.

However, if an overflow of streams occurs, the control unit 340 plays streams stored in the buffer in step 827. Then the control unit 340 determines whether an underflow of streams occurs in step 829. If an underflow of streams occurs, the control unit 340 returns to step 627 in FIG. 6.

On the other hand, if there is no play request input in step 823, the control unit 340 returns to step 817.

Returning to FIG. 6, in step 627, the control unit 340 determines whether a request for ending the current multimedia streaming service is input. If there is a request for ending the current multimedia streaming service, the control unit 340 performs a necessary process for ending a multimedia streaming service. If there is not a request for ending the current multimedia streaming service, the control unit 340 returns to step 611.

As discussed above, a mobile communication device according to exemplary embodiments of the present invention determines a buffering size being optimized depending on a multimedia server. This allows a mobile communication device to infrequently perform communicating actions required between a mobile communication device and a multimedia server in a case of an overflow of streams or an underflow of streams in a buffer. Accordingly, power consumption for a multimedia streaming service may be reduced.

Additionally, when receiving a keep-alive request message from a multimedia server, a mobile communication device according to exemplary embodiments of the present invention sends a keep-alive response message after a keep-alive critical period expires. This allows a mobile communication device to infrequently perform communicating actions required between a mobile communication device and a multimedia server in case of a pause in the multimedia streaming service. Accordingly, power consumption for a multimedia streaming service may be reduced.

While this invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for a multimedia streaming service in a mobile communication device comprising a buffer for storing multimedia streams transmitted from a multimedia server, the method comprising:
determining a buffering size of the buffer according to characteristic information of the multimedia streams;
storing the multimedia streams, transmitted from the multimedia server, in the buffer; and
playing the multimedia streams stored in the buffer.

2. The method of claim 1, wherein the determining of the buffering size comprises:
determining whether the characteristic information comprises a multimedia stream expiration date;
if the character information comprises the multimedia stream expiration date, assigning a minimum buffering size; and
if the character information does not comprise the multimedia stream expiration date, determining whether the characteristic information comprises an association time-out period.

3. The method of claim 2, wherein the determining of the buffering size further comprises:
if the character information comprises the association time-out period, assigning a specific buffering size corresponding to the association timeout period; and
if the character information does not comprise the association time-out period, assigning a maximum buffering size.

4. The method of claim 3, further comprising:
transmitting a stream pause message if an overflow of the multimedia streams, which comprises an amount of the multimedia streams stored in the buffer, exceeds an upper critical threshold value based on the buffering size.

5. The method of claim 4, further comprising:
transmitting a stream request message if an underflow of the multimedia streams, which comprises an amount of the multimedia streams stored in the buffer, falls below a lower critical threshold value based on the buffering size.

6. A method for a multimedia streaming service in a multimedia streaming service system having a multimedia server and a mobile communication device with a buffer for storing multimedia streams, the method comprising:
storing at the mobile communication device the multimedia streams transmitted from the multimedia server in the buffer;
playing at the mobile communication device the multimedia streams stored in the buffer;
when receiving a stream pause request from the mobile communication device, stopping at the multimedia server a transmission of the multimedia streams and sending a keep-alive request message to the mobile communication device; and
when receiving the keep-alive request message from the multimedia server, determining at the mobile communication device whether a keep-alive critical period expires, and, if the keep-alive critical period expires, sending a keep-alive response message to the multimedia server.

7. The method of claim 6, further comprising:
when receiving the keep-alive response message from the mobile communication device, determining at the multimedia server whether a pause allowed period expires, and, if the pause allowed period expires after the receiving of the keep-alive response message, sending again the keep-alive request message to the mobile communication device.

8. The method of claim 6, wherein the sending of the keep-alive request message is performed, if a pause allowed period expires after the transmitting of the multimedia streams is stopped.

9. The method of claim 7, wherein the stream pause request of the mobile communication device occurs when the playing of the multimedia streams is paused at the mobile communication device.

10. The method of claim 7, wherein the stream pause request of the mobile communication device occurs if an overflow of the multimedia streams, which comprises an amount of the multimedia streams stored in the buffer, exceeds an upper critical threshold value based on a buffering size.

11. The method of claim 7, further comprising:
transmitting at the multimedia server the transmission-stopped multimedia streams, when receiving a stream request from the mobile communication device.

12. A system for a multimedia streaming service, the system comprising:
a multimedia server for storing multimedia streams and characteristic information thereof, and transmitting the multimedia streams in response to a stream request message; and
a mobile communication device, which comprises a buffer for determining a buffering size of the buffer according to the characteristic information of the multimedia streams, for storing the multimedia streams transmitted from the multimedia server in the buffer and for playing the multimedia streams stored in the buffer.

13. The system of claim 12, wherein the mobile communication device assigns a specific buffering size corresponding to an association time-out period, if the characteristic information does not comprise a multimedia stream expiration date and comprises the association time-out period.

14. The system of claim 13, wherein the mobile communication device assigns a minimum buffering size, if the characteristic information comprises the multimedia stream expiration date.

15. The system of claim 13, wherein the mobile communication device assigns a maximum buffering size, if the characteristic information comprises neither the multimedia stream expiration date nor the association time-out period.

16. The system of claim 12, wherein the mobile communication device comprises a control unit for transmitting a stream service request message to the multimedia server.

17. The system of claim 13, wherein the mobile communication device comprises a control unit for determining the buffering size.

18. The system of claim 13, wherein the mobile communication device comprises a control unit for determining whether a stream response message to the stream request message transmitted to the multimedia server comprises the association time-out period.

19. The system of claim 12, wherein the mobile communication device transmits a stream pause request message to the multimedia server.

20. The system of claim 19, wherein the multimedia server stops transmitting the multimedia streams, sends a keep-alive request message to the mobile communication device and receives a keep-alive response message from the mobile communication device when a keep-alive critical period expires.
